(19) United States
(12) Patent Application Publication
(10) Pub. No.: US 2026/0109217 A1
(43) Pub. Date: Apr. 23, 2026

(54) AUTOMOBILE ELECTRIC GENERATOR SYSTEM WITH A CONSTANT SPEED DRIVE

(71) Applicant: David Bassoo, Goodyear, AZ (US)

(72) Inventor: David Bassoo, Goodyear, AZ (US)

(21) Appl. No.: 18/922,802

(22) Filed: Oct. 22, 2024

(51) Int. Cl. B60K 17/28; B60K 17/04; B60L 1/00; B60L 1/02; B60L 1/14; B60L 50/60; B60L 53/16

(52) U.S. Cl. CPC B60K 17/28; B60K 17/04; B60L 1/003; B60L 1/02; B60L 1/14; B60L 50/60; B60L 53/16

(57) ABSTRACT

An automobile electric generator system incorporating a battery and a constant speed drive. Electricity is generated from the rotational movement of the automobile's wheel axles. The rotational movement is transmitted through the constant speed drive, to an electric generator, to an alternator, to an inverter, and then to a storage battery. The storage battery is then adapted to providing energy back to the wheel axles to aid in the rotational movement thereof, along with providing electricity to other electrical components within the automobile.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to automobile electric generators, and more specifically to automobile electric generators incorporating a battery and a constant speed drive.

### 2. Description of the Related Art

Prior art automobile electric generators are directly connected to a rotating portion of the drive train and speed up and slow down along with the rotational motion of the drive train. This produced an enormous strain on the generator and results in fluctuating power therefrom. This results in short term and long term damage to the generator and the other electrical components downstream therefrom.

In another embodiment of the prior art, jet engines vary in speed from taxiing on the ground, to take off, to flight, and then landing. Larger aircraft tend to have A/C electrical systems to run the avionics and electrical accessories on the plane. Aircraft usually have a generator that needs to turn at a specific RPM to provide adequate power to the plane. Since the RPM of the jet engine varies, they needed something to turn the generator at the specific RPM. If the generator RPM were too fast, it could tear the generator apart. If it's too slow it will not provide enough power to the aircraft. As the jet engine turns, it is designed to have a gear box where necessary items are attached. One of these items is something called a Constant Speed Drive (CSD). Engineers designed the CSD, which is integrated into the electrical system, to act as a sort of transmission. The CSD is attached to the engine on one end and attached to the generator on the other. As the engine turns at different speeds, the CSD will take the speed at the jet engine end and adjust it to the desired speed, to provide a constant speed to the generator. This ensures the generator is always turning at the desired RPM. Similarly, like a car driving uphill or downhill, the engine RPM may vary resulting in the same problem, wherein if the RPM were too fast, it could tear a generator apart. Furthermore, within an electric vehicle (EV), there are no moving parts. Therefore, there is no ability to use an alternator that a normal car uses to charge a battery while it is driving.

Accordingly, the present invention overcomes the disadvantages associated with the prior art, by providing an automobile electric generator system that incorporates a constant speed drive, which would convert the fluctuating rotational movement and provide a constant rotational movement to the alternator for providing stable electrical power to the components downstream therefrom.

### BRIEF SUMMARY OF THE INVENTION

In view of the foregoing disadvantages inherent in the known types of automobile electric generators or the like in the prior art, the present invention provides an improved automobile electric generator system. As such, the general purpose of the present invention, which will be described subsequently in greater detail, is to provide an automobile electric generator system incorporating a battery and a constant speed drive adapted to convert fluctuating rotational movement from an automobile's wheel axles and provide constant rotational movement to an alternator for providing stable electrical power to a storage battery, which is then adapted to provide energy back to the automobile's wheel axles to aid in the rotational movement thereof, along with providing electricity to other electrical components within the automobile, with all the advantages of the prior art and none of the disadvantages.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments according to the teachings of the present invention.

FIG. 1 shows a perspective view of an electric automobile incorporating the automobile electric generator system with a constant speed drive according to the preferred embodiment of the present invention.

FIG. 2 shows a cut-away view of the electric automobile incorporating the automobile electric generator system with a constant speed drive according to the preferred embodiment of the present invention of FIG. 1.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

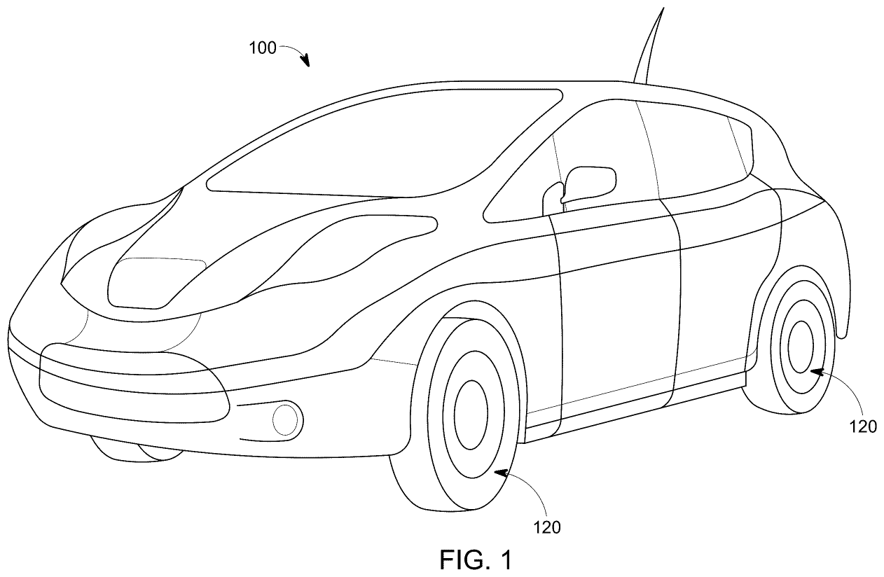

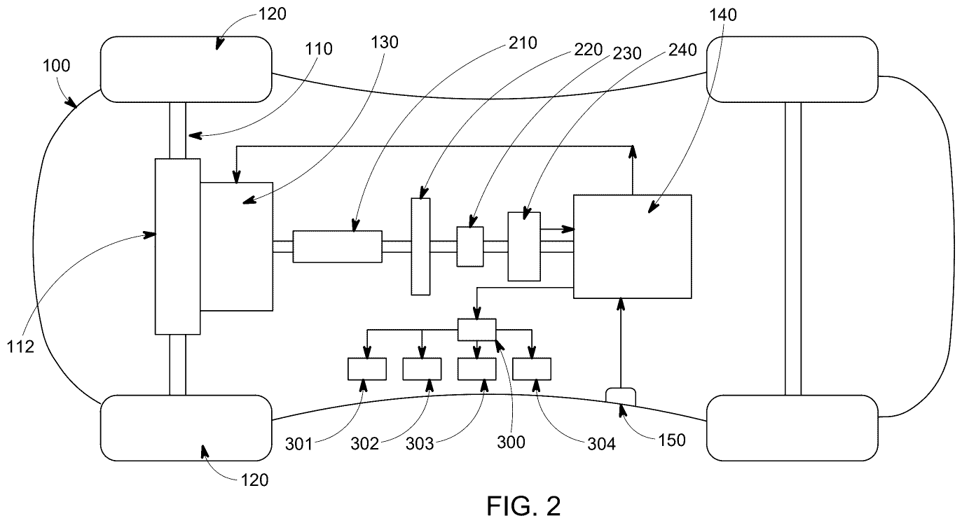

Turning now descriptively to drawing, referring to FIGS. 1-2, the present invention discloses an automobile electric generator system for use within an electric automobile to thereby recover unused energy from the mechanical components of the electric car and transfer them back into the battery of the car, thereby increasing the energy efficiency of the electric car. incorporating a battery and a constant speed drive. As such, the electric automobile 100 includes at least one wheel axle 110, at least one wheel 120 mechanically attached to axle 110, an electric motor 130 adapted to rotate wheel axle 110 and thereby wheels 120 to thereby propel the electric automobile 100, a transmission 112 mechanically connected between the electric motor and wheel axle 110, a battery 140 adapted to provide electric power to the electric motor 130; and an automobile electric generator system comprising a constant speed drive 210 adapted to be connected to the at least one wheel axle 110 of the automobile, wherein the constant speed drive 210 is adapted to convert fluctuating rotational movement from the at least one wheel axle 110 and provide constant rotational movement to an alternator, an electric generator 220 mechanically connected to the constant speed drive 210 and adapted to convert rotational movement of the constant speed drive into electrical power, an alternator 230 electrically connected to the electric generator 220 and is adapted to control and convert the electric power from the electric generator for use within the automobile, an inverter 240 electrically connected to the alternator 230 and is adapted invert the electric power from the alternator for use by the battery 140 of the electric automobile 100, wherein the inverter 240 is electrically connected to the battery 140 of the electric automobile, wherein the electric power generated by the automobile electric generator system is transferred to the battery 140, which is then used by the battery to power the electric motor 130 to thereby propel the electric automobile 100, and as such the energy efficiency of the electric automobile is increased and the battery life of the battery is increased.

The electric automobile 100 further includes a car inverter 300 electrically connected to the battery 140 and is adapted to invert electric energy from the battery to be used by electric components of the electric automobile, wherein the electric components include an air conditioning unit 301, a heating unit 302, lighting fixtures 303, and electrical outlets 304. Furthermore, the electric automobile includes a charging port 150 adapted to connect with an external power source and charge the battery.

The aforementioned system may also be used in other types of vehicles or product that uses electricity for power, including cars, semi-trucks, locomotives, and ships. Furthermore, the instant system may also be used for applications and products that have no battery to store a charge.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. An automobile electric generator system comprising:
a constant speed drive;
wherein said constant speed drive is adapted to be connected to an automobile's wheel axles; and
wherein said constant speed drive is adapted to convert fluctuating rotational movement from an automobile's wheel axles and provide constant rotational movement to an alternator;
an electric generator;
wherein said electric generator is mechanically connected to said constant speed drive and adapted to convert said rotational movement of said constant speed drive into electrical power;
an inverter;
wherein said inverter is electrically connected to said electric generator and is adapted to invert the electric power from said electric generator for use within said automobile; and
a battery;
wherein said battery is electrically connected to said inverter and is adapted to store the electric power from said inverter; and
wherein said battery is adapted to be electrically connected to an electric motor that is connected to said automobile's wheel axles;
wherein said electric power from said battery is adapted to be used by said electric motor that is connected to said automobile's wheel axles; and
wherein said electric motor is adapted to provide rotational movement to said automobile's wheel axles.

2. The automobile electric generator system of claim 1, further comprising:
an alternator;
wherein said alternator is electrically connected to said electric generator and is adapted to control and convert the electric power from said electric generator for use within said automobile.

3. A combination of an electric automobile and an automobile electric generator system, comprising:
an electric automobile including:
at least one wheel axle;
at least one wheel;
wherein said at least one wheel is mechanically attached to said axle;
an electric motor;
wherein said electric motor is adapted to rotate said at least one wheel axle and thereby said at least one wheel, and thereby propel said electric automobile; and
a battery;
wherein said battery is adapted to provide electric power to said electric motor; and
an automobile electric generator system;
a constant speed drive;
wherein said constant speed drive is adapted to be connected to said at least one wheel axle of said automobile; and
wherein said constant speed drive is adapted to convert fluctuating rotational movement from said at least one wheel axle and provide constant rotational movement to an alternator;
an electric generator;
wherein said electric generator is mechanically connected to said constant speed drive and adapted to convert said rotational movement of said constant speed drive into electrical power; and
an inverter;
wherein said inverter is electrically connected to said electric generator and is adapted to invert the electric power from said electric generator for use within said automobile; and
wherein said inverter is electrically connected to said battery of said electric automobile;
wherein said electric power generated by said automobile electric generator system is transferred to said battery, which is then used by said battery to power said electric motor to thereby propel said electric automobile, and as such the energy efficiency of said electric automobile is increased and the battery life of said battery is increased.

4. The automobile electric generator system of claim 3, further comprising:
an alternator;
wherein said alternator is electrically connected to said electric generator and is adapted to control and convert the electric power from said electric generator for use within said automobile.

5. The combination of claim 3, wherein said electric automobile further includes a transmission mechanically connected between said electric motor and said at least one wheel axle.

6. The combination of claim 3, wherein said electric automobile further includes a car inverter electrically connected to said battery and is adapted to invert electric energy from said battery to be used by electric components of said electric automobile.

7. The combination of claim 6, wherein said electric components of said electric automobile are chosen from a list of electric components consisting of an air conditioning unit, a heating unit, lighting fixtures, and electrical outlets.

8. The combination of claim 3, wherein said electric automobile further includes a charging port adapted to connect with an external power source and charge said battery.
